(19) United States
(12) Patent Application Publication
(10) Pub. No.: US 2026/0321695 A1
(43) Pub. Date: Oct. 15, 2026

(54) MANUFACTURING METHODS AND COMPOSITIONS FOR ADVANCED POLYMER ELECTROLYTE MEMBRANES

(71) Applicant: University of Houston System, Houston, TX (US)

(72) Inventor: Anima B. BOSE, Houston, TX (US)

(73) Assignee: University of Houston System, Houston, TX (US)

(21) Appl. No.: 19/481,985

(22) PCT Filed: May 28, 2024
(86) PCT No.: PCT/US2024/031313

§ 371 Date: Nov. 6, 2025

Related U.S. Application Data
(60) Provisional application No. 63/504,448, filed on May 26, 2023.

(51) Int. Cl. H01M 8/1039; H01M 8/10; H01M 8/1081

(52) U.S. Cl. CPC H01M 8/1039; H01M 8/1081; H01M 2008/1095

(57) ABSTRACT

A method of manufacturing a polymer electrolyte membrane comprising solubilizing an ionomer in a first solvent to produce a solubilized ionomer; thermally-treating the solubilized ionomer to produce a thermally-treated solubilized ionomer; solubilizing a structuring agent in a second solvent to form a solubilized structuring agent; and contacting the thermally-treated solubilized ionomer with the solubilized structuring agent to form a composite solution; and casting the composite solution onto a substrate to form a cast membrane. An electrochemical device comprising a polymer membrane wherein the polymer membrane comprises a sulfonic acid containing-polymer and a structuring agent characterized by an extent of entanglement of from about 5% to about 25%.

### CROSS-REFERENCE TO RELATED APPLICATIONS

This application is a 35 U.S.C. § 371 national stage application of PCT/US2024/031313 filed May 28, 2024, and entitled “Manufacturing Methods and Compositions for Advanced Polymer Electrolyte Membranes,” which claims benefit of U.S. Provisional Application Ser. No. 63/504,448 filed May 26, 2023, and entitled “MANUFACTURING METHODS AND COMPOSITIONS FOR ADVANCED POLYMER ELECTROLYTE MEMBRANES,” each of which is hereby incorporated herein by reference in its entirety for all purposes.

### STATEMENT REGARDING FEDERALLY SPONSORED RESEARCH OR DEVELOPMENT

This invention was made with government support under DE-EE0003666 awarded by the U.S. Department of Energy. The government has certain rights in the invention.

### TECHNICAL FIELD

The present disclosure relates to renewable energy systems. More specifically, the present disclosure relates to methods of manufacturing improved polymer electrolyte membranes and membrane electrode assemblies comprising same.

### BACKGROUND

Fuel cells have attracted the attention of researchers as promising energy converters because of their high energy efficiency and low or zero emissions. Fuel cells are electrochemical devices which produce usable electricity by the catalyzed combination of a fuel such as hydrogen and an oxidant such as oxygen. A fuel cell is not a energy storing device, it does not store chemicals but instead delivers power as long as chemicals are supplied from outside.

Polymer electrolyte membrane fuel cells (PEMFCs) are the most promising candidates among the various types of fuel cells for future various applications because of their quick start-up, high energy density at low operating temperatures, zero emissions, and system robustness. A membrane electrode assembly is the central element of a PEMFC, such as a hydrogen fuel cell. Typical membrane electrode assemblies comprise a polymer electrolyte membrane (PEM), which functions as a solid electrolyte. The PEM typically plays three major roles: (i) effectively separating both the fuel and oxidant by preventing mixing, (ii) acting as an insulator to electron flow through, and (iii) transporting protons from the anode to the cathode to complete the redox reaction chemistry.

In a membrane electrode assembly (MEA), the face of the PEM is in contact with an anode electrode layer and the opposite face is in contact with a cathode electrode layer. In typical use, protons are formed at the anode via hydrogen oxidation and transported across the PEM to the cathode to react with oxygen, causing electrical current to flow in an external circuit connecting the electrodes. Each electrode layer includes electrochemical catalysts such as platinum metal. The PEM forms a durable, non-porous, electrically non-conductive mechanical barrier between the reactant gases, but passes H⁺ ions readily. Gas diffusion layers (GDL's) facilitate gas transport to and from the anode and cathode electrode materials and conduct electrical current. The GDL is both porous and electrically conductive, and is typically composed of carbon fibers. The GDL may also be called a fluid transport layer (FTL) or a diffuser/current collector (DCC). The anode and cathode electrode layers may be applied to GDL's and the resulting catalyst-coated GDL's sandwiched with a PEM to form a five-layer membrane electrode assembly. FIG. 1 depicts an exemplary PEMFC.

The PEM is a component of both electrolyzers and flow battery systems. The electrolyzer is a split system that can divide water or carbon dioxide molecules into valuable fuels such as hydrogen gas, oxygen, methanol, formic acid, and C₂-C₃ compounds via the applied electrical energy. Additionally, the flow battery is one of the electrochemical storage cell systems where chemical energy is provided by two chemical components dissolved in liquids that are pumped through the system on separate sides and in opposite directions of a membrane and ion transfer inside the cell through the PEMs. MEAs of electrolyzer and flow battery is similar in construction to fuel cell MEAs in that they have a catalyst layer applied to both faces of an electrolyte membrane, but this is where the similarity ends. MEA for electrolyzer and redox flow batteries requires different catalysts, different gas diffusion layers, and different membranes, primarily to reduce gas/fuels diffusion and provide mechanical strength when operated at high differential pressures, among many characteristics. Hence, the durability of PEM plays a key role in the stability and durability of electrolyzer and flow batteries including operating under differential pressure and harsh conditions such as strong acid media.

The NAFION™ brand ionomer membrane is most widely used in electrochemical devices because of its excellent chemical stability, high ionic conductivity, and mechanical strength when compared to other types of PEMs. The NAFION™ brand of PEM has been the established 50 years plus benchmark for performance validation of many alternative energy applications from fuel cells to flow batteries to water electrolyzers. However, the NAFION™ membrane suffers from issues such as poor mechanical stability, poor selectivity, and high manufacturing cost. Additionally, the NAFION™ brand PEM can undergo flooding which reduces the mechanical stability of the membrane. Hence, the durability of a PEM plays a key role in the stability and durability of electrolyzer and flow batteries including operating under differential pressure and harsh conditions such as strong acid media. An ongoing need exists for methods and compositions that address the aforementioned challenges with PEMs.

### BRIEF DESCRIPTION OF THE FIGURES

The following figures form part of the present specification is included to further demonstrate certain aspects of the present disclosure. The subject matter of the present disclosure may be better understood by reference to the figure in combination with the detailed description of specific aspects presented herein.

FIG. 1 is a schematic depiction of a membrane electrode assembly (MEA).

FIG. 2A is a transmission electron micrograph of a fine thin film formed from a polymer solution of the type disclosed herein.

FIG. 2B is a transmission electron micrograph of the carbon element dispersion for a film formed from a polymer solution of the type disclosed herein.

FIG. 2C is a transmission electron micrograph of the silica element dispersion for a film formed from a polymer solution of the type disclosed herein.

FIG. 2D is a transmission electron micrograph of the sulfur element dispersion for a film formed from a polymer solution of the type disclosed herein.

FIG. 3 is a bar graph of the tensile strength for the indicated composite membranes prepared using different casting procedures compared to available commercial membrane.

FIG. 4A is a graph of the tensile stress as a function of tensile strain for the indicated composite membrane compared to NAFION™ membrane repaired at the same procedure-3.

FIG. 4B is a bar graph depicting the percent weight loss for the indicated samples after testing with Fenton's reagent.

FIG. 5A is a graph of the weight percentage water uptake as a function of temperature for the indicated samples.

FIG. 5B is a graph of the swelling ratio as a function of temperature for the indicated samples.

FIG. 5C is a graph of the proton conductivity as a function of temperature for the indicated samples.

FIG. 6 depicts graphs of the voltage as a function of current density for the indicated samples.

FIG. 7 are graphs of the voltage as a function of time for the indicated samples.

FIG. 8A are graphs of the voltage and power density as a function of current density for the membrane electrode assemblies having a NAFION™ membrane before and after 200 hours of the long-term stability test.

FIG. 8B is a graph of the voltage and power density as a function of current density for membrane electrode assemblies having a NAFION™-plus membrane before and after 200 hours of the long-term stability test.

FIG. 9A is a graph of the voltage as a function of current density at 40° C. and the indicated percent relative humidity for a membrane electrode assembly having a NAFION™-plus membrane.

FIG. 9B is a graph of the power density as a function of current density at 40° C. and the indicated percent relative humidity for a membrane electrode assembly having a NAFION™-plus membrane.

FIG. 9C is a graph of the voltage as a function of current density at 60° C. and the indicated percent relative humidity for a membrane electrode assembly having a NAFION™-plus membrane.

FIG. 9D is a graph of the power density as a function of current density at 60° C. and the indicated percent relative humidity for a membrane electrode assembly having a NAFION™-plus membrane.

FIG. 9E is a graph of the voltage as a function of current density at 80° C. and the indicated percent relative humidity for a membrane electrode assembly having a NAFION™-plus membrane.

FIG. 9F is a graph of the power density as a function of current density at 80° C. and the indicated percent relative humidity for a membrane electrode assembly having a NAFION™-plus membrane.

FIG. 10A depicts Nyquist Plots of NAFION™-plus MEA at the indicated percentage relative humidity operated on H₂/O₂ at 40° C.

FIG. 10B depicts Nyquist Plots of NAFION™-plus MEA at the indicated percentage relative humidity operated on H₂/O₂ at 60° C.

FIG. 10C depicts Nyquist Plots of NAFION™-plus MEA at the indicated percentage relative humidity operated on H₂/O₂ at 80° C.

FIG. 11 depicts graphs of the water electrolysis performance of NAFION™ and NAFION™-plus membrane electrode assemblies at 30° C.

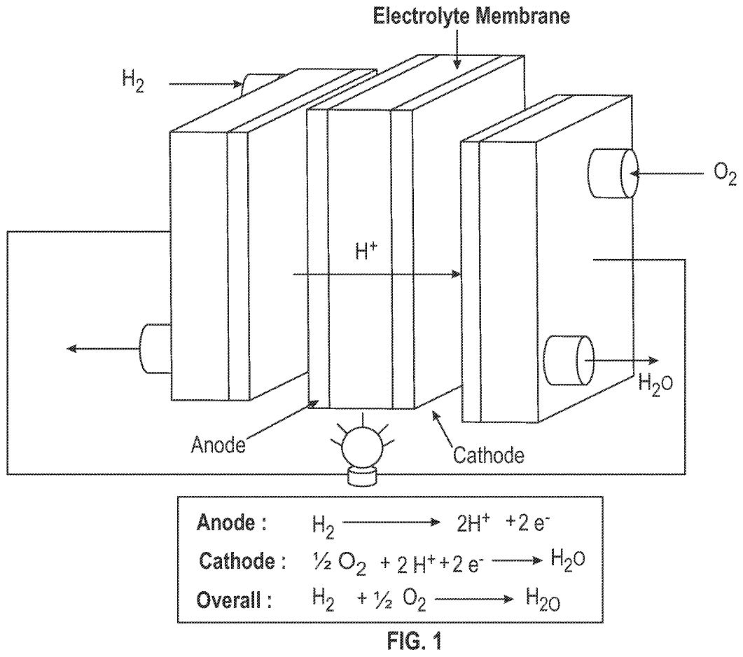

While the subject matter disclosed herein is susceptible to various modifications and alternative forms, only a few specific aspects have been shown by way of example in the drawing and are described below in detail. The figures and detailed descriptions of these specific aspects are not intended to limit the breadth or scope of the subject matter disclosed or the appended claims in any manner. Rather, the figures and detailed written descriptions are provided to illustrate the present disclosure to a person skilled in the art and to enable such person to make and use the concepts disclosed herein.

### SUMMARY

Disclosed herein is a method of manufacturing a polymer electrolyte membrane comprising solubilizing an ionomer in a first solvent to produce a solubilized ionomer; thermally-treating the solubilized ionomer to produce a thermally-treated solubilized ionomer; solubilizing a structuring agent in a second solvent to form a solubilized structuring agent; and contacting the thermally-treated solubilized ionomer with a solubilized structuring agent to form a composite solution; and casting the composite solution onto a substrate to form a cast membrane.

Also disclosed herein is a fuel cell comprising a polymer membrane wherein the polymer membrane comprises a sulfonic acid containing polymer and a structuring agent characterized by an extent of entanglement of from about 5% to about 25%.

### DETAILED DESCRIPTION

Disclosed herein are compositions and methods for the manufacture of an improved polymer electrolyte membrane, designated PEM*. Further disclosed herein are membrane electrode assemblies (MEAs), fuel cells (FC) and electrolysis devices (e.g., water, carbon dioxide) having a PEM* disposed therein.

In one or more aspects, the present disclosure describes compositions and methods to produce PEM*s characterized by increased mechanical and chemical stabilities, increased performance and durability, and reduced propensity for flooding. In an aspect, a PEM* comprises a NAFION™ type ionomer, alternatively a NAFION™ type ionomer membrane. In one or more aspects, a method of the present disclosure comprises formation of a cast membrane comprising a sulfonic acid containing-polymer and a structuring agent, alternatively a perfluorinated sulfonic acid polymer and a structuring agent. In one or more aspects, the perfluorinated sulfonic acid polymer comprises the NAFION™ brand.

In one or more aspects, a method of the present disclosure comprises formation of a PEM*. A PEM* may be formed from a mixture of (1) a sulfonic acid containing-polymer and (2) a structuring agent. Nonlimiting examples of sulfonic acid containing-polymers suitable for use in the present disclosure include [poly(4-styrenesulfonic acid)(PSS), poly(anetholesulfonic acid)(PAS), poly(vinylsulfonic acid)(PVS), poly(2-acrylamido-2-methyl-1-propanesulfonic acid)(PAMPS)] tetra-fluoroethylene (TFE) with perfluoro (3,6-dioxa-4-methyl-7-octenesulfonyl fluoride, perfluorosulfonic acid and perfluorosulfonic acid polytetrafluoroethylene (PFSA) copolymers.

In one or more aspects, the sulfonic acid containing-polymer comprises a perfluorinated sulfonic acid polymer, or alternatively a perfluorosulfonic acid polytetrafluoroethylene (PFSA) copolymer A PEM* of the present disclosure may comprise the sulfonic acid containing-polymer in an amount of from about 92 weight percent (wt. %) to about 99 wt. %, alternatively from about 93 wt. % to about 99 wt. %, or alternatively from about 94 wt. % to about 99 wt. % based on the total weight of the composite membrane.

It is contemplated that a structuring agent of the type disclosed herein may impart properties such as increased mechanical strength, resistance to flooding and the like to other polymer membrane systems. Nonlimiting examples of other polymers that may be combined with a structuring agent to form membranes having improved properties include cellulose acetate (CA), polyacrylonitrile (PAN), polyimide, polycarbonate (PC), polyethylene (PE), polypropylene (PP), (olyvinylidenefluoride, ethylene chlorotrifluoroethylene, polyethersulfone, polyphenylsulfone polytetrafluoroethylene, perfluoropolyether, and alkaline polyolefins.

It is contemplated that a structuring agent of the type disclosed herein may impart properties such as increased mechanical strength, resistance to flooding and the like to other polymer membrane systems. Nonlimiting examples of other polymers that may be combined with a structuring agent to form membranes having improved properties include cellulose acetate (CA), polyacrylonitrile (PAN), polyimide, polycarbonate (PC), polyethylene (PE), polypropylene (PP), (olyvinylidenefluoride, ethylene chlorotrifluoroethylene, polyethersulfone, polyphenylsulfone polytetrafluoroethylene, perfluoropolyether, and alkaline polyolefins.

In one or more aspects, the structuring agent used to form the PEM* is any material able to reinforce the structural integrity of the formed PEM*. Without wishing to be limited by theory, the structuring agent may mitigate swelling of the membrane and enhance the performance and durability of a polymer membrane.

In one or more aspects, the structuring agent comprises an oligomeric silsesquioxane. In one or more aspects, the structuring agent comprises oligomeric silsesquioxane polyhedrals. Oligomeric silsesquioxane polyhedrals (OSP) are sub-members of inorganic-organic hybrid materials mostly containing 3D cage-like building blocks made of silicon/oxygen structure (RSiO₃/₂)ₙ, where R is a hydrogen or a hydrocarbon-based (i.e., hydrocarbyl) group (e.g., aryl, alkylene, alkyl, and arylene). The term “hydrocarbon” whenever used in this specification and claims refers to a compound containing only carbon and hydrogen. The term “hydrocarbyl group” is used herein in accordance with the definition specified by IUPAC: a univalent group formed by removing one or more hydrogen atoms from a hydrocarbon. Nonlimiting examples of these groups include, by way of example, aryl, arylene, arene, alkyl, alkylene, alkane, cycloalkyl, cycloalkylene, cycloalkane, aralkyl, aralkylene, and aralkane groups, among other groups, as members. The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified. Primary, secondary, and tertiary alkyl groups are derived by removal of a hydrogen atom from a primary, secondary, or tertiary carbon atom, respectively, of an alkane. The n-alkyl group can be derived by removal of a hydrogen atom from a terminal carbon atom of a linear alkane. Herein an arene refers to an aromatic hydrocarbon, with or without side chains. An “aryl group” is a group derived from the formal removal of a hydrogen atom from an aromatic ring carbon of an arene. Similarly, an “arylene group” refers to a group formed by removing two hydrogen atoms (at least one of which is from an aromatic ring carbon) from an arene.

Structuring agents suitable for use in the present disclosure (e.g., OSP) are characterized by chemical resistance, high modulus, and thermal stability as well as the organic polymer properties like ductility, processability and low toxicity. In one or more aspects, the structuring agent (e.g., OSP) is present in the PEM* in an amount of from about 1 wt. % to about 8 wt. %, alternatively from about 2 wt. % to about 7 wt. % or alternatively from about 2 wt. % to about 4 wt. % based on the weight of the composite membrane.

The membrane may be formed using any suitable methodology for forming membranes. Generally, the method involves evaporation of a solvent (or a mix of solvents) from a starting polymer solution and subsequent formation of a polymeric membrane by precipitation. In this process, a polymer is dissolved in a suitable solvent and the solution obtained is spread out across an appropriate support. Then, the solvent is left to evaporate, in an inert atmosphere or controlled environment, inducing the polymer precipitation and membrane formation.

In one or more aspects of the present disclosure, a PEM* is prepared by solubilizing a sulfonic acid-containing-polymer (e.g., sodium-based NAFION™) in a suitable solvent to form a homogenous polymer solution. In some aspects, the solvent is an eco-friendly solvent. Herein an eco-friendly solvent refers to solvents that are generally characterized as being easily recycled, biodegradable and possessing low toxicity. In some aspects, the eco-friendly solvent is obtained from the processing of agricultural crops or otherwise sustainable methods as alternatives to petrochemical solvents. In an aspect, the solvent comprises alcohols. In alternative aspects, the solvent comprises acetone, ethanol, methanol, 2-propanol, ethyl acetate, isopropyl acetate, methyl ethyl ketone, or combinations thereof. In one or more aspects, the methods and conditions used for preparation of a membrane may utilize these solvents.

As will be understood by one of ordinary skill in the art, the amount of sulfonic acid containing-polymer and amount of solvent will depend on various factors such as the solvent used, polymer molecular weight, and dissolving conditions (e.g., temperature). For example, from about 4 g to about 6 g sulfonic acid containing-polymer can be solubilized in from about 100 ml to about 120 ml of solvent, alternatively from about 4 g to about 6 g sulfonic acid containing-polymer can be solubilized in from about 60 ml to about 80 ml of solvent or alternatively from about 4 g to about 6 g sulfonic acid containing-polymer can be solubilized in from about 20 ml to about 40 ml of solvent.

Solubilization of the sulfonic acid containing-polymer powder may be carried out at elevated temperatures such as greater than about 40° C., alternatively greater than about 50° C., alternatively greater than about 60° C. or alternatively from about 40° C. to about 80° C.

In one or more aspects, a method of the present disclosure comprises solubilizing a structuring agent (e.g., OSP) in an ecofriendly solvent of the type disclosed herein. In some aspects, the sulfonic acid containing-polymer and structuring agent are solubilized in the same solvent, alternatively the sulfonic acid containing-polymer and structuring agent are solubilized in different solvents.

In one or more aspects, a composite solution comprising the sulfonic acid containing-polymer and structuring agent is formed by the addition of the solubilized sulfonic acid containing-polymer to the solubilized structuring agent solution. In one or more aspects, addition of the solubilized sulfonic acid containing-polymer to the solubilized structuring agent solution is metered. Metered addition of the solubilized sulfonic acid containing-polymer to solubilized structuring agent solution may be carried out manually (e.g., manual dropwise addition) or may be automated (e.g., using an injector calibrated to provide a predetermined amount of solubilized polymer over a predetermined time). The composite solution containing the sulfonic acid containing-polymer and structuring agent, may be subjected to further processing.

In some aspects, further processing comprises agitation and/or thermal treatment in order to facilitate entanglement between the structuring agent and sulfonic acid containing-polymer. For example, the rate of agitation of the composite solution may be increased to 2 times the initial rate of agitation, alternatively 5 times or alternatively 10 times for a time period ranging from about 6 hours to about 72 hours, alternatively about 10 hours to about 60 hours or alternatively from about 10 hours to 50 hours.

As will be understood by one of ordinary skill in the art, the time for complete dispersion of the structuring agent in the polymer at a given concentration will vary. The entanglement between polymer (e.g., sulfonic acid-containing polymer) and the structuring agent may be determined by any suitable methodology. In one or more aspects, the extent entanglement is monitored by measuring the viscosity of the composite solution, for example using a viscosimeter. The extent of entanglement results in an increased viscosity of the composite solution. In one or more aspects, the extent of entanglement is monitored by determining the haze of the composite solution. It is observed that as the extent of entanglement increases the haziness of the solution increases. In some aspects, the extent of entanglement is determined by measuring both the composite solution viscosity and haze as a function of time.

In one or more aspects, the composite solution is allowed to achieve a viscosity that is indicative of an extent of entanglement within the ranges disclosed herein while being a flowable liquid. The dispersion process continues until the composite solution becomes less transparent and the viscosity increases to some predetermined level after a time period in the range of 6 hours to about 72 hours, alternatively from about 6 hours to about 36 hours or alternatively from about 12 hours to about 24 hours. For example, the viscosity may range from about 100 centipoise (cps) to about 2500 cps. The resultant material is termed a composite mixture.

In one or more aspects, the extent of entanglement of the sulfonic acid containing-polymer and structuring agent may range from about 5% to about 25%, alternatively from about 5% to about 20% or alternatively from about 10% to about 15%.

In an aspect, the composite solution is used to form a membrane via a solvent evaporation casting method. For example, the composite solution may be cast onto a suitable substrate (e.g., glass) and subsequently annealed at temperatures ranging from about 50° C. to about 190° C., alternatively from about 60° C. to about 180° C. or alternatively from about 120° C. to about 185° C. for time periods ranging from about 1 hour to about 8 hours, alternatively from about 1 hour to about 7 hours or alternatively from about 1 hour to about 6 hours, depending the season of the year.

In some aspects, annealing may be carried out in a plurality of stages where a single stage may be carried out in a predefined temperature range for a predefined time period which may be followed by one or more additional stages carried out at a differing temperature ranges for the same or a differing time periods. The resultant material is termed herein a pre-PEM*.

In one or more aspects, the pre-PEM* is contacted with an acidic solution in order to exchange the alkali or alkaline metal cation (e.g., sodium) associated with the sulfonic acid-containing polymer with a proton and produce the PEM*.

A method of the present disclosure may further comprise soaking and washing the PEM* with deionized water to remove any excess acid. The resultant PEM* may exhibit improved mechanical and performance properties when compared to an otherwise similar membrane prepared in the absence of a structuring agent and/or with a differing casting methodology.

In one or more aspects, the power density of a fuel cell comprising a PEM* of the present disclosure is increased by about 1.5 times when compared to a fuel cell prepared with a PEM lacking a structuring agent, alternatively from about 1.25 times to about 1.75 times, or alternatively from about 1.4 times to about 1.6 times. Specific power and power density are power per unit area, of the system and are usually expressed with units of W/cm². The power density delivered by a fuel cell is the product of the current density and the cell voltage at that current density.

In one or more aspects, a PEM* is characterized by an increased mechanical strength. For example, the tensile strength of the PEM* may be increased by equal to or greater than about 70% when compared to a neat NAFION™ (i.e., PEM) membrane prepared using the same procedure, in the absence of a structuring agent. Alternatively the PEM* has a tensile strength ranging from about 16 MPa to about 29 MPa or alternatively from about 20 MPa to about 29 MPa as determined in accordance with ASTM D638. Herein tensile strength refers to the ability of a plastic material to withstand a maximum amount of tensile stress without failure. The stress occurs while the material is being pulled or stretched and is the point when a material goes from elastic to plastic deformation.

In one or more aspects, a PEM* is characterized by a reduction in water flooding issue (for example as indicated by swelling of the membrane) by a factor of about 1.7 times, alternatively from about 1.1 times to about 2.0 times. In one or more aspects, a PEM* is characterized by a reduction in water flooding issue (for example as indicated by swelling of the membrane) by from about 5% to about 10%, or alternatively from about 9.09% to about 5.23% at 30° C. In one or more aspects, a PEM* is characterized by a reduction in water flooding issue (for example as indicated by swelling of the membrane) by from 12.12% to about 7.48% at 90° C. or alternatively by from 7% to about 15% at 90° C. when compared to a PEM prepared in the absence of a structuring agent.

In another aspect, the PEM* has a reduction in water uptake ranging from about 5% to about 25%, alternatively from about 5% to about 20% or alternatively from about 5% to about 15%. In an alternative aspect, the PEM* has no water accumulation such that water flooding of the PEM* does not occur during operation in fuel cell mode for a time period of equal to or less than about 30 days, alternatively equal to or less than about 20 days or alternatively equal to or less than about 10 days.

In one or more aspects of the present disclosure, the PEM* is characterized by a level of membrane degradation that is reduced when compared to the level of membrane degradation observed with a NAFION™ PEM membrane prepared following the same PEM* procedure. In such aspects, the membrane degradation is measured in accordance with the membrane electrode assembly degradation testing protocol described by the Department of Energy (2020), in which the membrane electrode assembly is operated at 90° C. of cell temperature; 30% of relative humidity for 500 h; a fuel/oxidant (H₂/O₂) with the stoichiometry of 10/10 at 0.2 A/cm² and an equivalent flow of 0.2 L/min. Without wishing to be limited by theory, the gas crossover through the membrane is one of the principal causes of the chemical degradation of electrolyte membrane which can result in the generation of radical species (H*, HO*, and HOO*) when the gases reach the metal ions. In one or more aspects, the membrane degradation of a PEM* is reduced by from about 0.90 mV/h to about 0.65 mV/h, alternatively from about 0.90 mV/h to about 060 mV/h or alternatively from about 0.90 mV/h to about 0.55 mV/h.

In one or more aspects, an electrochemical device comprising a PEM* has an electrochemical performance (e.g., potential difference) at temperatures ranging from about 25° C. to about 110° C. and a relative humidity of less than about 10% that is decreased by from about 5% to about 50%, alternatively from about 10% to about 50% or alternatively from about 20% to about 40% when compared to an otherwise similar device comprising a PEM lacking a structuring agent. It is to be understood the electrochemical performance used to evaluate the PEM* will depend on the type of electrochemical device.

Polymer electrolyte membranes have great promise as environmentally friendly technologies for diverse applications. For example, PEM fuel cell power sources has been adopted because no emission, quick start, and low temperature operation, especially for vehicle applications. The polymer electrolyte membrane (PEM) has a critical ion conducting capability use in fuel cell/electrolyzer/flow batteries for supporting green energy generation and clean power production. Thus, the PEM* of the present disclosure plays a vital role in offering electrochemical device development and beyond. The sulfonic acid group membrane, NAFION™ is the state-of-the-art membrane and requires full hydration to maintain efficient ion conductivity, but uncontrolled water absorbing behavior leads to weaker mechanical stability resulting an a decreased ability to withstand standard operating conditions and reduced lifetime.

A PEM* of the type disclosed herein can offer better selectivity and durability, and can reduce the cost of PEM based fuel cell/electrolyzer/flow battery technologies compared to currently employed state-of-the-art NAFION™ membrane. Thus, the disclosed subject matter could address the balanced solution of the gas/fuels crossover, electrochemical performances, and the water flooding management critical question for PEM advancement. It is contemplated, a PEM* of the type disclosed herein may be usefully employed in any device utilizing a membrane that would benefit from a membrane having attributes such as increased mechanical strength and increased durability.

### Additional Disclosure

The following are additional nonlimiting exemplary aspects of the presently disclosed subject matter

A first aspect which is a method of manufacturing a polymer electrolyte membrane comprising: solubilizing an ionomer in a first solvent to produce a solubilized ionomer; thermally-treating the solubilized ionomer to produce a thermally-treated solubilized ionomer; solubilizing a structuring agent in a second solvent to form a solubilized structuring agent; contacting the thermally-treated solubilized ionomer with a solubilized structuring agent to form a composite solution; casting the composite solution onto a substrate to form a cast membrane.

A second aspect which is the method of the first aspect wherein the ionomer comprises a sulfonic acid containing-polymer.

A third aspect which is the method of the second aspect wherein the sulfonic acid containing polymer comprises [poly(4-styrenesulfonic acid)(PSS), poly(anetholesulfonic acid)(PAS), poly(vinylsulfonic acid)(PVS), poly(2-acrylamido-2-methyl-1-propanesulfonic acid)(PAMPS)] tetra-fluoroethylene (TFE) with perfluoro (3,6-dioxa-4-methyl-7-octenesulfonyl fluoride, perfluorosulfonic acid (PFSA), perfluorosulfonic acid polytetrafluoroethylene (PTFE) copolymers or combinations thereof.

A fourth aspect which is the method of any of the second and third aspects wherein the sulfonic acid-containing polymer comprises a perfluorosulfonic acid polytetrafluoroethylene copolymer.

A fifth aspect which is the method of any of the first through fourth aspects wherein the structuring agent comprises an oligomeric silsesquioxane polyhedrals characterized by the general formula (RSiO₃/₂)n, where R is a hydrogen, an aryl group, an alkylene group, an alkyl group, arylene group or combinations thereof.

A sixth aspect which is the method of any of the first through fifth aspects wherein the first solvent, the second solvent or both comprise alcohols.

A seventh aspect which is the method of any of the first through sixth aspects wherein the first solvent, the second solvent or both comprise acetone, ethanol, methanol, 2-propanol, ethyl acetate, isopropyl acetate, methyl ethyl ketone, or combinations thereof.

An eighth aspect which is the method of any of the first through seventh aspects wherein thermally-treating comprises heating to a temperature of from about 40° C. to about 80° C.

A ninth aspect which is the method of any of the first through eight aspects wherein the composite solution has an extent of entanglement of the sulfonic acid containing-polymer and structuring agent of from about 5% to about 25%.

A tenth aspect which is the method of any of the first through ninth aspects further comprising annealing the cast membrane to form an annealed membrane.

An eleventh aspect which is the method of the tenth aspect wherein the cast membrane is annealed at a temperature of from about 60° C. to about 180° C.

A twelfth aspect which is the method of the tenth aspect wherein the cast membrane is annealed for a time of from about 2 hours to about 6 hours.

A thirteenth aspect which is the method of any of the first through twelfth aspects wherein the annealed membrane is characterized by a tensile strength that is increased by equal to or greater than about 70% when compared to a neat membrane prepared in the absence of a structuring agent.

A fourteenth aspect which is the method of any of the first through thirteenth aspects wherein the annealed membrane is characterized by a reduction in water uptake ranging from about 5% to about 25% when compared to a neat membrane prepared in the absence of a structuring agent.

A fifteenth aspect which is an electrochemical device comprising a polymer membrane wherein the polymer membrane comprises a sulfonic acid containing-polymer and a structuring agent characterized by an extent of entanglement of from about 5% to about 25%.

A sixteenth aspect which is the electrochemical device of the fifteenth aspect wherein the sulfonic acid containing-polymer comprises [poly(4-styrenesulfonic acid)(PSS), poly(anetholesulfonic acid)(PAS), poly(vinylsulfonic acid)(PVS), poly(2-acrylamido-2-methyl-1-propanesulfonic acid)(PAMPS)] tetra-fluoroethylene (TFE) with perfluoro (3,6-dioxa-4-methyl-7-octenesulfonyl fluoride, perfluorosulfonic acid (PFSA), perfluorosulfonic acid polytetrafluoroethylene (PTFE) copolymers or combinations thereof.

A seventeenth aspect which is the electrochemical device of any of the fifteenth through sixteenth aspects wherein the sulfonic acid containing-polymer comprises a perfluorosulfonic acid polytetrafluoroethylene copolymer.

An eighteenth aspect which is the electrochemical device of any of the fifteenth through seventeenth aspects wherein the structuring agent comprises an oligomeric silsesquioxane polyhedrals characterized by the general formula (RSiO₃/₂)n, where R is a hydrogen, an aryl group, an alkylene group, an alkyl group, arylene group or combinations thereof.

A nineteenth aspect which is the electrochemical device of any of the fifteenth through eighteenth aspects having a power density that is equal to or greater than about 1.5 times the power density of a fuel cell lacking a membrane comprising the sulfonic acid containing-polymer and structuring agent characterized by an extent of entanglement of from about 5% to about 25%.

A twentieth aspect which is the electrochemical device of any of the fifteenth through nineteenth aspects having a performance at temperatures ranging from about 25° C. to about 110° C. and a relative humidity of less than about 10% that is decreased by from about 5% to about 50% when compared to an otherwise similar device comprising a PEM lacking a structuring agent.

### EXAMPLE

The following examples are given as particular aspects of the present disclosure and demonstrate the practice and advantages thereof. It is understood that the examples are given by way of illustration and are not intended to limit the specification or the claims to follow in any manner.

### Example 1

A PEM* was prepared using a casting method. Specifically, for a 20×20 cm² membrane size, 2.5 g of sodium (Nat) base NAFION™ polymer powder was slowly dissolved into 25 g of an alcohol solvent at approximately 60° C. under mild agitation of solution for a time period of 20-26 hours to form a homogenous solution. The prepared polymer solution was diluted with additional solvent and stirred at the same temperature for about 72 hours. OSP (0.075 g) was dissolved into 5 g of the same solvent and stirred for 4 hours before being further diluted with solvent and stirring continued for another 20-26 hours. The polymer solution was then slowly added into the OSP solution to generate the NAFION™-composite solution (i.e., for preparing PEM*) containing 3 wt. % of OSP which was then vigorously agitated and stirred for from 10 h to 12 h, at 6° C. This solution was kept stirring for an additional 24 h to 36 h to allow for the entanglement of polymer with a OSP. Finally, a portion of solvent was slowly removed at 70° C. until the composite solution appeared to have 15 wt. % of coordination NAFION™/OSP complex (hereinafter this is a PEM* and termed NAFION™-plus) solution for casting a membrane (20 cm×20 cm) with thickness 18 μm-20 μm. The percentage of coordination NAFION™/OSP complex was calculated based on the difference in the weights of the solution before and after the evaporation process which was indicative of the amount of OSP complex incorporated in the membrane.

A maximum 20×20 cm² size membranes were prepared generally via a solvent evaporation casting method. The prepared NAFION™-plus solution was cast into a glass substrate using a doctor's blade. The membrane was then dried at 60° C. for 6 hours followed by drying at 90° C. for 2 hours at ambient pressure. These conditions allowed for network formation by solvent evaporation. Subsequently, the membrane was annealed for 2 hours at 140° C., 1 hour at 160° C. and 1-1.5 hours at 180° C., respectively. At the final step, the sodium (Nat) base NAFION™-plus membrane was transformed to proton (H+) base NAFION™-plus membrane by immersing in 200-250 ml of H₂SO₄ (2 M) for 48 hours at 60° C. Finally, the proton base NAFION™-plus membrane prepared using this general procedure was soaked and washed a few times with deionized (DI) water for 24 h before use.

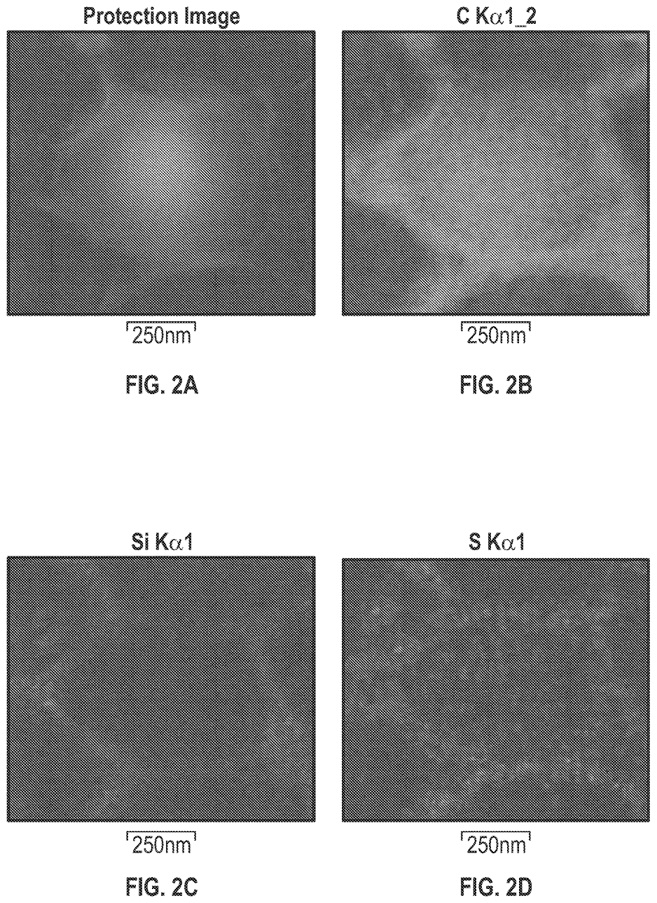

Uniform OSP dispersion in NAFION™-plus network was a factor for even enforcement of the membrane that would result in enhanced durability and stability. Transmission electron microscopy (TEM) was employed to understand the OSP dispersion in NAFION™-plus membrane. The sample was prepared in a TEM carbon grid from the polymer solution. The carbon (C), sulfur(S), and silicon-mapping of NAFION™-plus displays the very consistent Si dispersion where FIG. 2a displays attributes of film formation in the grid in general and FIGS. 2b,c & d represent the elemental map of carbon, silicon, and sulfur, respectively. OSP is the source of silicon in the membrane while the NAFION™ side chains is the source of sulfur.

Since the TEM grid was prepared from solution, higher polymer accumulation happened in the porous carbon ribs than in the open spaces of TEM grid, FIGS. 2b-d. The high carbon intensity in the rib area of FIG. 2b corresponds to the combination of carbon from carbon grid-rib and carbon of the NAFION™ backbone. Though the intensity of carbon in the open space is low compared to the rib area the dispersal is fairly uniform. A great similarity of Si and S can be seen in FIGS. 2c and 2d where S is the source of NAFION™ and Si the source of OSP was noticed across the grid, but higher concentration in the rib area was similar to carbon concentration. The high intensity of C, Si, and S signals across the TEM-grid rib area could be due to the entanglement of NAFION™ polymer around the OSP in porous ribs. Based on the images, it can be suggested that OSP (Si-mapping) dispersed very much uniformly in NAFION™-plus solution.

### Example 2

The effect of alterations in the casting method on the performance of the membrane were investigated. Specifically, a PEM* membrane was prepared using 3 different procedure. In the first procedure, Procedure 1, the membrane was cast by evaporating solvent at 60° C. and ambient pressure for 6 hr. Further evaporation was then carried under vacuum at 60° C. for 2 hours followed by cooling at room temperature at ambient pressure. The membrane was then annealed at 140° C. for 2 hours and then aa again at 180° C. for 1 hour. In the second procedure, Procedure 2, casting was performed through programable steps without cooling the membrane between the temperature treatment blocks. Consequently, the cast membrane was subjected to the following series of temperature changes, 60° C. to 80° C.; 100° C. to some steps are 140° C.; and 140° C. to 180° C. third procedure, Procedure 3, the mixing and timing process of the doped solution were extended by approximately 40-80 hours. Further in Procedure 3, the polymer solution was prepared with excess solvent and then condensed to a solution that ranged in polymer concentration from about 10 wt. % to about 25 wt. %. The remainder of Procedure 3 mirrored Procedure 1.

Mechanical properties of the membranes prepared by the three procedures were measured at the wet state at room temperature. Firstly, the prepared membrane (1 cm×5 cm) was immersed into the DI water for 24 h. Subsequently, the hydrated membrane was immediately applied into the testing system for obtaining tensile strength vs. elongation data using a Universal Testing Machine (UTM) system with a pulling force rate of 10 N min⁻¹.

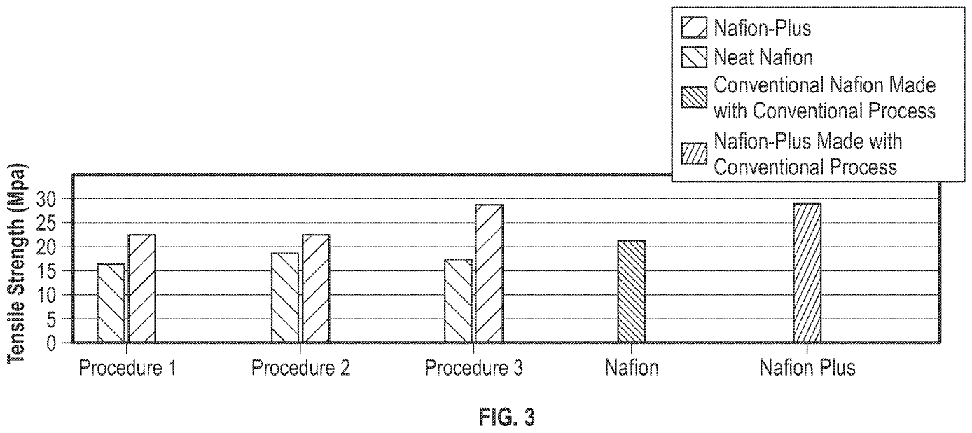

Procedures 1-3 represent alternative methods for preparing both NAFION™ (as reference) and NAFION™ Plus membranes. The tensile stress of the membranes produced as described herein was used to investigate the effect of an OSP on the mechanical property of electrolyte membranes with varying membrane fabrication procedures. The results are presented in FIG. 3. FIG. 3 illustrates that the NAFION™-plus membrane showed higher tensile stress than the NAFION™ membrane regardless of the casting procedure implemented. The NAFION™-plus prepared using Procedure-3 showed the highest tensile stress, 28 MPa compared to the tensile stress of membranes prepared using other procedures. Indeed, the tensile stress of NAFION™-plus was about 70% higher than the NAFION™ membrane when both membranes are prepared using Procedure 3 and was 30% higher than the NAFION™-plus membrane prepared using Procedure 1 or Procedure 2. These results demonstrated that the NAFION™-plus membrane fabricated by Procedure-3 is a new achievement to maintain excellent chemical stability.

### Example 3

The anti-oxidation stability of the prepared NAFION™, NAFION™-plus and state-of-the-art commercial (NAFION 212) membranes were measured by Fenton's reagent (4 wt. % H₂O₂ and 4 ppm Fe²⁺ in FeSO₄·6H₂O form). The membranes were 3 cm×3 cm in size. Dry membranes were immersed in the Fenton's solution at 60° C. After 48 hours, the membranes were washed 3 times in DI water and dried in a vacuum oven at 80° C. for 24 h. The weight loss (WL) of the tested membranes was calculated by using the weight before and after treatment in the Fenton's reagent, as shown in equation (1).

$$WL ( wt \% ) = \frac{{m}_{before} - {m}_{after}}{{m}_{before}} \times 100 \qquad ( 1 )$$

where, WL (wt. %), mafter, and mbefore are the weight loss percentage the weight of dry membrane after and before treatment in Fenton's reagent, respectively.

The water absorbance (uptake) and swelling ratio of the prepared electrolyte membranes (NAFION™ and NAFION™-plus) were obtained by the weight and length change of the membranes between dry and wet states at different temperatures. In brief, the test samples (1 cm×3 cm) were cut from the prepared membranes after drying at 80° C. for 24 h in a vacuum oven, then the samples were immersed into the DI water for 24 h at temperatures ranging from 30° C. to 90° C. Following this step, the weight and length of the samples were recorded after removing the surface water of the membrane by blotting with soft wiper. The water uptake and swelling ratio of electrolyte membranes were calculated as shown in equations (2) and (3):

where, WU (%), SR (%), mwet, Lwet, mdry, and Ldry are the water uptake and swelling

$$WU ( \% ) = \frac{{m}_{wet} - {m}_{dry}}{{m}_{dry}} \times 100 \qquad ( 2 )$$

$$SR ( \% ) = \frac{{L}_{wet} - {L}_{dry}}{{L}_{dry}} \times 100 \qquad ( 3 )$$

ratio, the weight and length of sample at wet and dry state, respectively.

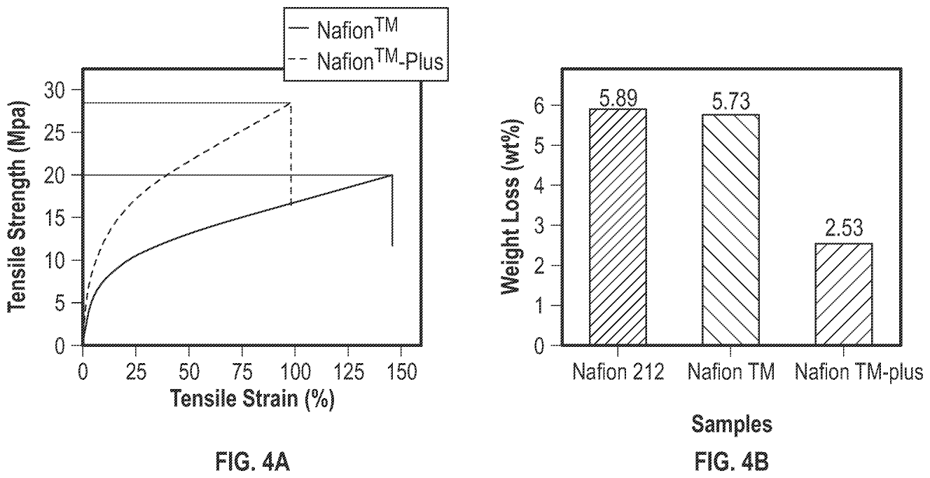

The mechanical properties of the membranes were tested by carrying out tensile strain versus stress experiment. The results are presented in FIG. 4. FIG. 4a is the tensile stress vs. strain of the prepared electrolyte membrane at full hydrate state and room temperature. The NAFION™-plus membrane reproduced the highest mechanical stress at 28 MPa, which is 40% higher than that of the neat NAFION™ membrane at 18 μm of thickness.

While the tensile strain of NAFION™-plus membrane decreased from 150% to 100% with the presence of 3 wt. % of OSP. Indeed, the presence of 3D OSP nanostructure along with entanglement time and temperature explained in Procedure-3 significantly improved the mechanical property of the membrane, which can possibly be explained through two factors: (1) the entanglement of polymer around 3D OSP control the polymer from free-movement and (2) since the polymer chain was constrained around OPS, the side chain was confined around OSP and could not absorb unlimited water. Thus, it reduced the water uptake and swelling

FIG. 4b is a bar graph of the weight loss observed after treatment in the Fenton's test solution at 60° C. for the recent state-of-the-art NAFION™ 212 and membranes prepared as disclosed herein. The NAFION™-plus membrane demonstrated excellent chemical stability with a weight loss of only 2.53 wt. % after 48 h treatment, which is 2-fold lower than that of the state-of-the-art NAFION™ 212 (5.98 wt. %) and recast NAFION™ membrane (5.73 wt. %). The generation of radicals such as HO*, HOO* and H* is the principal reason leading to the degradation of polymer structure during PEM fuel cell operation due to the attachment of these radicals into the ether bonds and tertiary carbon of NAFION structure to begin a series of decomposition reactions. Lesser water uptake by the NAFION™-plus membrane could prevent these destructive radicals from entering the membrane. Thus, it could increase the anti-oxidation properties of the electrolyte membrane.

### Example 4

The in-plane proton conductivity of the prepared membranes was measured as a function of temperature through a 4-probe cell approach where reactant humidification was done using a fuel cell test station (850e, Scribner), and the membrane resistance was recorded using a potentiostat hardware. Firstly, the resistance of prepared membranes was recorded according to the Cyclic Voltammogram process with the vertex potential range from −0.3V to 0.3V and a scan rate of 10 mV cm⁻¹. Then, the in-plane conductivity of the electrolyte membrane was calculated following equation (4).

$$σ ( S {cm}^{- 1} ) = \frac{L}{R \times T \times W} \qquad ( 4 )$$

where, σ (S cm⁻¹) is the in-plane proton conductivity of electrolyte membranes, R (Ohm) is the resistance of membrane, L (cm) is the length of two electrode of the cell, W (cm) and T (cm) are the width and the thickness of electrolyte membrane, respectively.

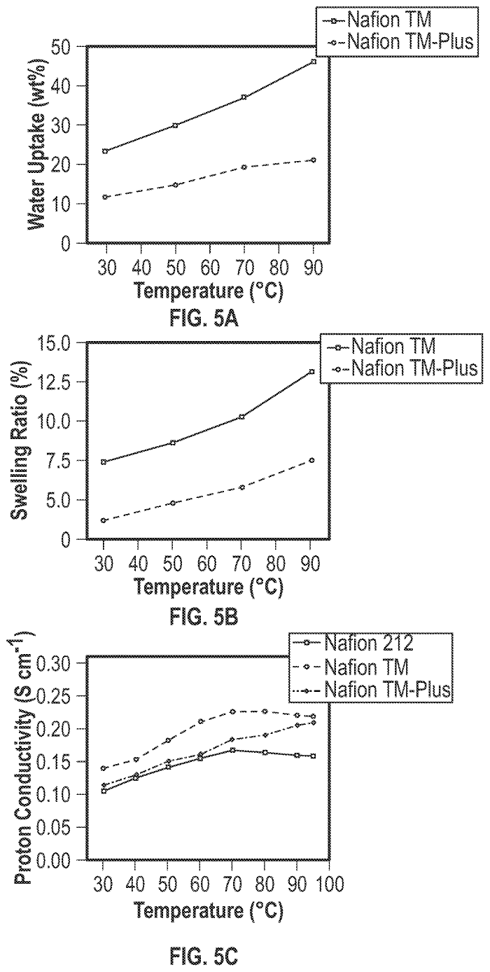

Hydration properties and proton conductivity are one of the principal properties of electrolyte membrane for both water electrolysis and fuel cell applications because it directly affects the ion transportability and degradation of electrolyte membrane. A new benchmark electrolyte membrane should show high proton conductivity at low water uptake amount, especially without external humidification. The addition of OSP nanomaterial demonstrated that this structuring agent could decrease the water uptake and swelling ratio of electrolyte membrane, while not affecting the proton transferability of the electrolyte membrane. Based on the unique 3D structure of the OSP nanomaterial, it could gather with hydrophobic C-F zone and help to increase the amount of crystal hydrophobic zone after the annealing process. Thus, it could push out the free water from the network and as a result created a more defined hydrophobic channel for diffusing the H+ more effectively. The performance difference between plain NAFION™ and NAFION™-plus is shown in FIGS. 5a and 5b.

For instance, the swelling ratio of NAFION™-plus and NAFION™ membrane was determined to be 7.5% and 15% while the proton conductivity was determined to be 0.186 and 0.193 S cm⁻¹ at 90° C., respectively. Additionally, the presence of OSP in the NAFION™-plus could prevent water evaporation at high temperature. As shown in FIG. 5c, the NAFION™ and NAFION 212 membrane have a tendency to decrease proton conductivity at a temperature higher than 80° C., while that of NAFION™-plus membrane still slightly increased until 95° C. Separation between the hydrophilic and hydrophobic phase can possibly occur during the annealing phase. In the case of the NAFION™-Plus membrane further congregating happened between hydrophobic C-F zone and OSP nanoparticle that increased the defined phase separation between hydrophilic and hydrophobic phases of the NAFION™-plus membrane. Thus, the interaction between water molecules increased the affinity stronger to hydrophilic function of the NAFION™-plus membrane structure and thus decreased the defined path for ions to follow effectively resulting in enhanced performance.

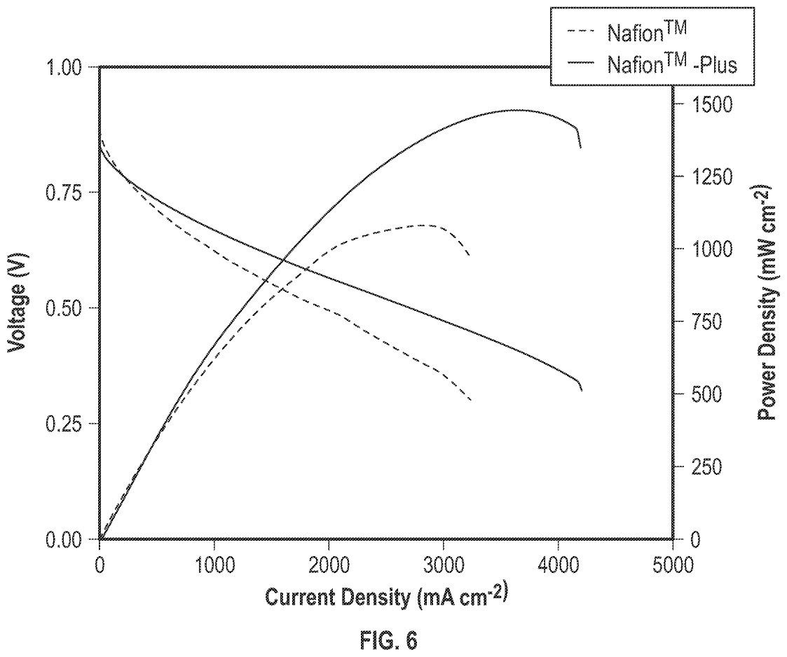

Although the proton conductivity of NAFION™ and NAFION™-plus at 80° C. is quite similar, the maximum peak power density of NAFION™-plus is 1.5-fold higher than that of NAFION™ MEA, as shown in FIG. 6. Indeed, the maximum power density peak of NAFION™ and NAFION™-plus are about 1000 mWcm⁻² and 1500 mWcm⁻², respectively. These results demonstrated the excellent water retention ability of OSP nanomaterials at high temperatures.

### Example 5

Membrane electrode assemblies of NAFION™ and NAFION™-plus membranes were prepared based on the ink spray method. Firstly, a catalyst having 0.125 g of Pt/C (20 wt. % of Pt), 1 g of NAFION™ solution (5 wt. %), 1 mL of water and 4 mL of isopropyl alcohol was sonicated for 5 mins using an ultrasonicate system and then was stirred for 3 days. Subsequently, the catalyst ink was deposited onto both sides of the electrolyte membranes for fabricating 5 cm² membrane electrode assemblies. The temperature was kept fixed at 50° C. using a UV light during the depositing process. The catalyst loading was 0.3 mg and 0.4 mg of Pt/cm² for the anode and cathode respectively. Finally, the membrane electrode assemblies were assembled with GDLs on both sides of the membrane coated electrodes by hot-pressing at 150° C. for 6 mins.

The polarization i-V curves of fuel cell performance were measured at different temperatures and relative humidity (% RH). The membrane electrode assembly containing GDLs was inserted into a PEMFC hardware with 5 cm² of active area. The membrane electrode assembly was then pre-treated at 70° C. and 80% relative humidity (RH) following a rapid voltage cycling procedure while the hydrogen and oxygen gas flow-rate were fixed at 0.2 L min−1. Following this step, the i-V polarization curves of the membrane electrode assembly was recorded using an 850e Fuel Cell Test System (Scribner Associates Inc.). Nyquist plots of membrane electrode assemblies were also measured at the sample testing conditions with a current density of 1 A m-2, and a frequency range of 0.05 Hz to 10 MHz.

For comparison purposes, the fuel cell long-term stability test was also carried out using membranes sized to 5 cm² NAFION™ and NAFION™-plus MEAs conducted through 850e Fuel Cell Test System where both membrane electrode assembly compositions remained the same except for the membranes. This study was conducted by following the Department of Energy membrane electrode assembly degradation protocol operating at 90° C. cell temperature, 30% of relative humidity, 10/10 of the fuel/oxidant (H₂/O₂) stoichiometry, and equivalent flow at 0.2 L/min (2016 Fuel Cell section, Page 3.4-48 Multi-Year Research, Development, and Demonstration Plan, Fuel cell Technologies Office, U.S. DoE). The time dependence of voltage at 0.2 A/cm² of current density was recorded during 500 hours of operation recommended in DoE MEA degradation protocol. Additionally, to understand the degradation behavior, the performance of membrane electrode assemblies was recorded after 200 h of durability test at 80° C. and 100% RH.

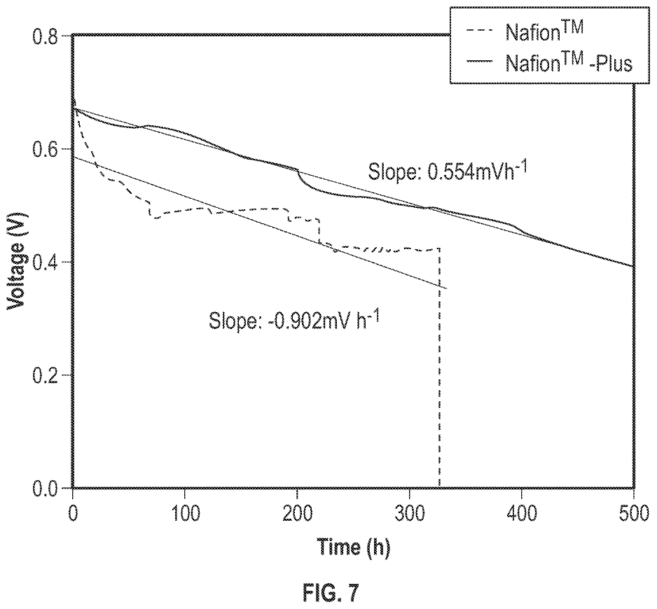

The results are presented in FIG. 7. Overall, the NAFION™-plus MEA still worked very well after 500 h with 0.4 V at 0.2 A/cm², while the NAFION™ MEA is significantly decayed and broken after 320 h at the same testing condition. Additionally, the voltage loss rate over time of NAFION™-plus MEA is 0.55 mV/h which is 60% less than that of the NAFION™ MEA (0.90 mV/h).

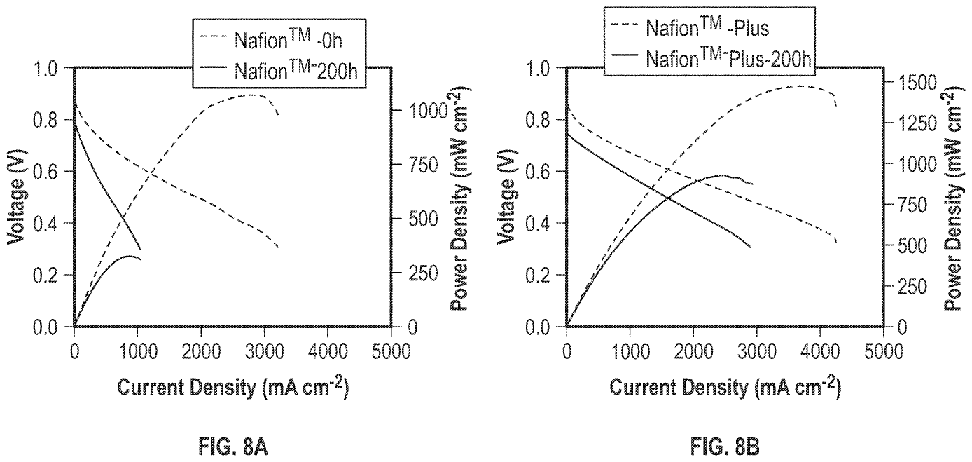

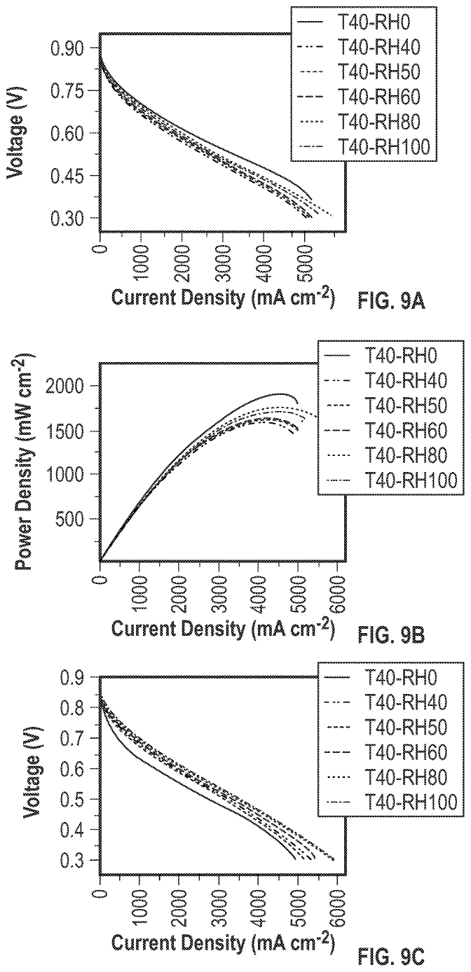

A similar behavior can be observed when monitoring the degradation of i-V polarization curves after 200 h long-term stability treatment for NAFION™, FIG. 8A and NAFION™-plus, FIG. 8B. The maximum power density peak of the NAFION™ membrane electrode assembly decreased by over 70% from 1074 mW/cm² to 330 mW/cm² after 200 h long-term stability test, whereas the maximum power density of the NAFION™-plus membrane electrode assembly decreased by only 37% from 1478 mW/cm² to 930 mW/cm² after the same time period during the durability test. These results demonstrated that the durability of the NAFION™-plus period was significantly improved via the presence of the OSP as a structuring agent. The addition of OSP could reduce the swelling of a PEM* in the full hydration condition. Thus, it could prevent the fuel/oxidant cross-through of the membrane. Furthermore, a reduced swelling ratio also helps the NAFION™-plus membrane maintain durability under the influence of physical factors under harsh operating conditions such as high temperature and the full hydrated state.

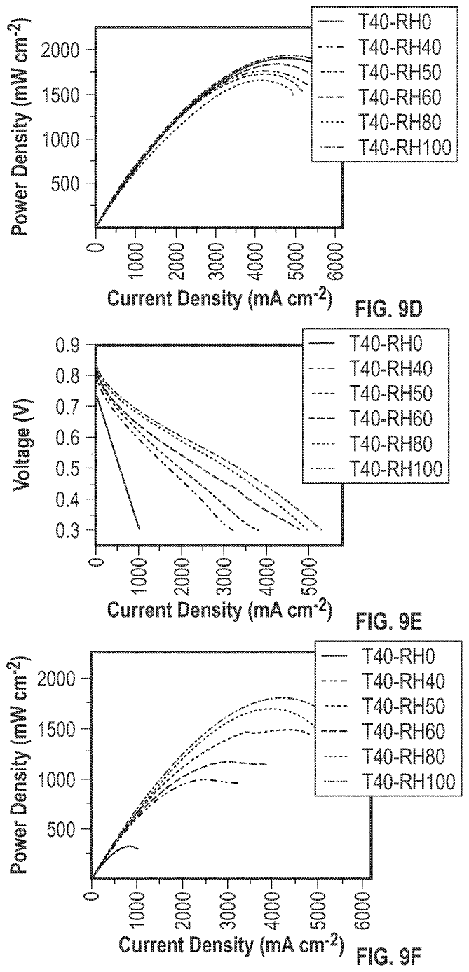

FIGS. 9 a-d clearly indicate that NAFION™-plus offers a stable performance at lower temperatures in the range of 40° C. and 60° C. even at without the presence of external humidification (sometimes referred to as 0% RH). The i-V curves also demonstrate that NAFION™-plus performs at 40° C. with 0% RH very much similar to 100% RH operated at 80° C. For instance, the current density at 0.6 V of all NAFION™-plus MEAs at 40° C. and 60° C. is about 1600 and 2000 mA cm⁻², respectively. The result distinctly demonstrated that the fuel cell performance of NAFION™-plus MEA does not fully depend on RH when the cell operates at lower temperature; (e.g., 1600 mA/cm² at 40° C.). This was a surprisingly beneficial advantage of the PEM*. A reasonable explanation of the obtained result would be that the water molecules generated are retained within the cell and maintain the proton conductivity through restructured membrane electrolyte especially at low temperature operation. At higher temperature, 80° C. for example, the generated current density at 0.6 V of NAFION™-plus based membrane electrode assembly with 0% RH is 380 mA cm⁻², which is 6-fold lower than that of 100% RH (2195 mA cm⁻²), shown in FIGS. 9e-f.

NAFION™ in general requires hydration, since the PEM* contains 97% NAFION™ influence, poor performance at 0% RH and at high temperatures like 80° C. would be expected. However, surprisingly, there was no difference in the performance of the MEA having a PEM* was observed between 80% and 100% RH at 80° C., and only a 2-fold drop in performance was observed with 40% external humidity. Though in principle the water molecules generated from the electrochemical reaction will be quickly evaporated under high temperature, it is contemplated that the ion clusters of the PEM* are more defined due to the entanglement of NAFION™ chain with 3-D structured OSP for vehicular H⁺ without much difficulty. It is not proven fully but it has been realized that OSP does not allow for the complete dehydration once the PEM* restructures hydrophilic and hydrophobic zones after initial conditioning. These results confirmed again that a PEM* of the present disclosure has a very high potential to become a new benchmark proton exchange membrane for a large range of operating temperatures.

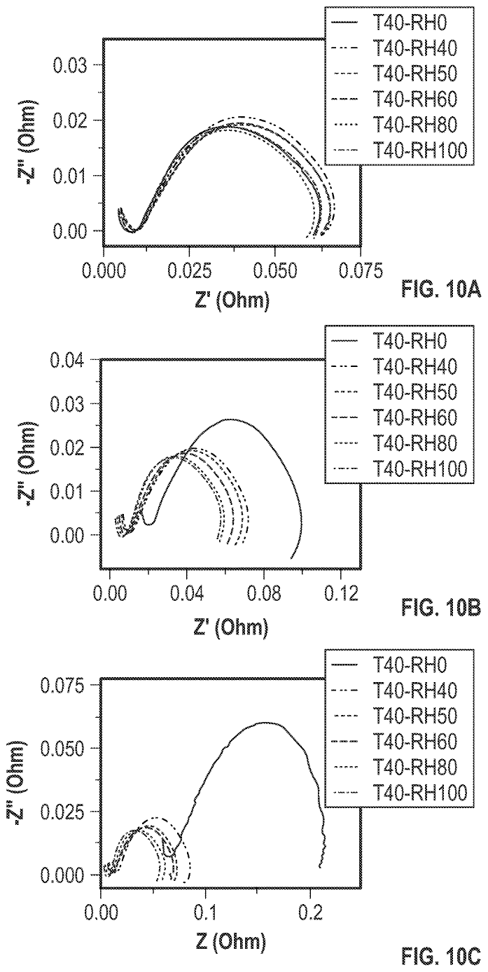

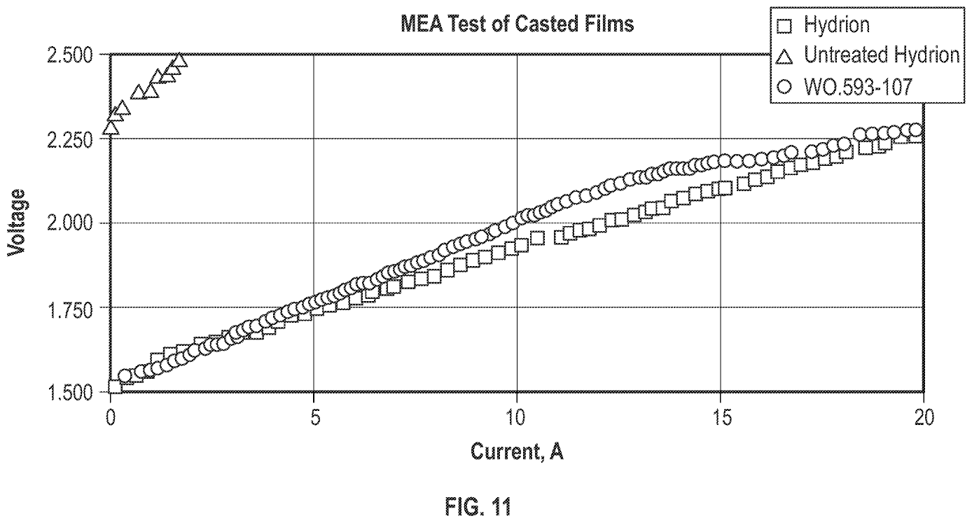

The Nyquist plots presented in FIG. 10 support the cell performance results. With reference to FIG. 10, i-V polarization curves of a MEA including the NAFION™-plus operated at 40° C., 60° C. and 80° C., show the high frequency intercept of MEA operated 40° C. does not change significantly at all employed % RH. This result is also evident in FIG. 8a. As operating temperatures increased, the frequency intercept distinctly shifts towards lower frequency with lower % RH, at both 60° C. and 80° C. where very poor charge transfer resistance is observed at 0% RH as shown in FIGS. 8b and 8c. These plots suggest higher resistance in H⁺ conductivity occurs at lower % RH at 80° C. compared to 60° C. and 40° C. with the NAFION™-Plus MEA.

### Example 6

PEM water electrolysis tests of NAFION™ and NAFION™-plus MEA (32 cm² of active area) were carried out at room temperature under diffusion process. Due to the lack of in-house facilities, this study was conducted by Ion Power Inc. The PEM water electrolysis performance was generated from 32 cm² single cell water electrolysis and the results are shown in FIG. 11. The data presented in FIG. 11 was obtained from NAFION™-Plus and the NAFION™ membranes tested at room temperature and conducted through plain diffusion process by means of the facility of Ion Power Inc. Both membrane electrode assemblies (NAFION™-Plus and NAFION™) were fabricated with equal thickness and identical uniform electrodes to allow for an accurate comparison. It was be observed that the water splitting active overpotential of both NAFION™-Plus and NAFION™-Plus membrane electrode assemblies were about 1.5 V at room temperature though it was slightly higher than the theoretical values of PEM water electrolysis (1.24 V). The i-V curve of NAFION™-Plus membrane electrode assemblies was comparable to the performance of the state-of-art membrane electrode assembly where both assemblies achieved 20 A at the overpotential about 2.25 V. This result demonstrated that the presence of 3 wt. % of OSP did not significantly affect the ion transfer ability of NAFION™-Plus, but the incorporation of OSP did help NAFION™ in maintaining controlled swelling and increase the mechanical stability by about 70%. Carbon dioxide transport was also observed using a PEM* of the type disclosed herein.

While various aspects of the present disclosure have been shown and described, modifications thereof can be made by one skilled in the art without departing from the spirit and teachings of the present disclosure. The aspects of the present disclosure described herein are exemplary only, and are not intended to be limiting. Many variations and modifications of the present disclosure are possible and are within the scope of the present disclosure. Where numerical ranges or limitations are expressly stated, such express ranges or limitations should be understood to include iterative ranges or limitations of like magnitude falling within the expressly stated ranges or limitations (e.g., “from about 1 to about 10” includes, 2, 3, 4, etc.; “greater than 0.10” includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as “comprises”, “includes”, “having, etc. should be understood to provide support for narrower terms such as “consisting of”, “consisting essentially of”, “comprised substantially of”, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present disclosure. The discussion of a reference in the present disclosure is not an admission that it is prior art to the present disclosure, especially any reference that may have a publication date after the priority date of this application. The present disclosure of all patents, patent applications, and publications cited herein are hereby incorporated by reference, to the extent that they provide exemplary, procedural or other details supplementary to those set forth herein.

All publications, patent applications, and patents mentioned herein are incorporated by reference in their entirety. In the event of conflict, the present specification, including definitions, is intended to control. With respect to all ranges disclosed herein, such ranges are intended to include any combination of the mentioned upper and lower limits even if the particular combination is not specifically listed.

1. A method of manufacturing a polymer electrolyte membrane comprising: solubilizing an ionomer in a first solvent to produce a solubilized ionomer;
thermally-treating the solubilized ionomer to produce a thermally-treated solubilized ionomer;
solubilizing a structuring agent in a second solvent to form a solubilized structuring agent;
contacting the thermally-treated solubilized ionomer with a solubilized structuring agent to form a composite solution; and
casting the composite solution onto a substrate to form a cast membrane.

2. The method of claim 1, wherein the ionomer comprises a sulfonic acid containing-polymer.

3. The method of claim 2, wherein the sulfonic acid containing polymer comprises [poly(4-styrenesulfonic acid)(PSS), poly(anetholesulfonic acid)(PAS), poly(vinylsulfonic acid)(PVS), poly(2-acrylamido-2-methyl-1-propanesulfonic acid)(PAMPS)] tetra-fluoroethylene (TFE) with perfluoro (3,6-dioxa-4-methyl-7-octenesulfonyl fluoride, perfluorosulfonic acid (PFSA), perfluorosulfonic acid polytetrafluoroethylene (PTFE) copolymers, or combinations thereof.

4. The method of claim 2, wherein the sulfonic acid-containing polymer comprises a perfluorosulfonic acid polytetrafluoroethylene copolymer.

5. The method of claim 1, wherein the structuring agent comprises an oligomeric silsesquioxane polyhedrals characterized by the general formula (RSiO₃/₂)ₙ, where R is a hydrogen, an aryl group, an alkylene group, an alkyl group, arylene group or combinations thereof.

6. The method of claim 1, wherein the first solvent, the second solvent or both comprise alcohols.

7. The method of claim 1, wherein the first solvent, the second solvent or both comprise acetone, ethanol, methanol, 2-propanol, ethyl acetate, isopropyl acetate, methyl ethyl ketone, or combinations thereof.

8. The method of claim 1, wherein thermally-treating comprises heating to a temperature of from about 40° C. to about 80° C.

9. The method of claim 1, wherein the composite solution has an extent of entanglement of the sulfonic acid containing-polymer and structuring agent of from about 5% to about 25%.

10. The method of claim 1, further comprising annealing the cast membrane to form an annealed membrane.

11. The method of claim 10, wherein the cast membrane is annealed at a temperature of from about 60° C. to about 180° C.

12. The method of claim 10, wherein the cast membrane is annealed for a time of from about 2 hours to about 6 hours.

13. The method of claim 1, wherein the annealed membrane is characterized by a tensile strength that is increased by equal to or greater than about 70% when compared to a neat membrane prepared in the absence of a structuring agent.

14. The method of claim 1, wherein the annealed membrane is characterized by a reduction in water uptake ranging from about 5% to about 25% when compared to a neat membrane prepared in the absence of a structuring agent.

15. An electrochemical device comprising a polymer membrane wherein the polymer membrane comprises a sulfonic acid containing-polymer and a structuring agent characterized by an extent of entanglement of from about 5% to about 25%.

16. The electrochemical device of claim 15, wherein the sulfonic acid containing-polymer comprises [poly(4-styrenesulfonic acid)(PSS), poly(anetholesulfonic acid)(PAS), poly(vinylsulfonic acid)(PVS), poly(2-acrylamido-2-methyl-1-propanesulfonic acid)(PAMPS)] tetra-fluoroethylene (TFE) with perfluoro (3,6-dioxa-4-methyl-7-octenesulfonyl fluoride, perfluorosulfonic acid (PFSA), perfluorosulfonic acid polytetrafluoroethylene (PTFE) copolymers or combinations thereof.

17. The electrochemical device of claim 15, wherein the sulfonic acid containing-polymer comprises a perfluorosulfonic acid polytetrafluoroethylene copolymer.

18. The electrochemical device of claim 15, wherein the structuring agent comprises an oligomeric silsesquioxane polyhedrals characterized by the general formula (RSiO₃/₂)ₙ, where R is a hydrogen, an aryl group, an alkylene group, an alkyl group, arylene group or combinations thereof.

19. The electrochemical device of claim 15, having a power density that is equal to or greater than about 1.5 times the power density of a fuel cell lacking a membrane comprising the sulfonic acid containing-polymer and structuring agent characterized by an extent of entanglement of from about 5% to about 25%.

20. The electrochemical device of claim 15, having a performance at temperatures ranging from about 25° C. to about 110° C. and a relative humidity of less than about 10% that is decreased by from about 5% to about 50% when compared to an otherwise similar device comprising a PEM lacking a structuring agent.
